(19) United States
(12) Patent Application Publication
(10) Pub. No.: US 2026/0270709 A1
(43) Pub. Date: Sep. 10, 2026

(54) System and method for configuring mobile device security

(71) Applicant: Bank of America Corporation, Charlotte, NC (US)

(72) Inventors: Abhijit Behera, Hyderabad (IN); Maneesh Kumar Sethia, Hyderabad (IN); Sivashalini Sivajothi, Chennai (IN)

(21) Appl. No.: 19/071,310

(22) Filed: Mar. 5, 2025

(51) Int. Cl. H04W 12/128

(52) U.S. Cl. CPC H04W 12/128

(57) ABSTRACT

A system for detecting eSIM (embedded Subscriber Identity Module) related fraudulent attacks from malicious user devices. The system receives an eSIM monitoring request from the first user device. The system then collects and stores a plurality of eSIM configuration parameters, the plurality of biometric parameters, and the plurality of device parameters associated with the first user device. The system then executes an AI algorithm using the collected plurality of biometric parameters and the plurality of device parameters as input, wherein the AI algorithm is configured to generate the baseline user profile associated with the first user of the first user device as output. The system then determines if an eSIM modification request is to be denied or slowed based on the baseline user profile.

### TECHNICAL FIELD

The present disclosure relates generally to network and device monitoring and, more specifically, to a system and method for configuring mobile device security.

### BACKGROUND

A SIM card or SIM (Subscriber Identity Module) may be an integrated circuit (e.g., a physical “SIM card”) that is intended to securely store an international mobile subscriber identity (IMSI) number and its related key, used to identify and authenticate users on mobile devices. In some examples, a SIM can be an embedded SIM (eSIM), which is a programmable SIM (i.e., a digital version of the physical SIM card) that is embedded directly into the mobile device. An eSIM is a digital SIM that facilitates a connection to a mobile network without a physical SIM card. eSIMs are vulnerable to fraudulent attacks by bad actors. A type of eSIM-related fraudulent attack involves a potential cloning of an eSIM profile for malicious purposes, which compromises network security as well as data security for the mobile device user. For example, bad actors (i.e., malicious user devices) can impersonate a user of the mobile device to perform eSIM cloning. This can result in undesirable disclosure of information, detrimental utilization of user accounts, and/or unauthorized transfers of funds.

### SUMMARY

The disclosed system, described in the present disclosure, is particularly integrated into a practical application of configuring mobile device security. The disclosed system addresses technical problems rooted in mobile device wireless communications and achieves technical improvements to the network and the user devices used in wireless communications, as well as underlying computer systems that facilitate wireless communications.

The system and method implemented by the system, as disclosed in the present disclosure, provide technical solutions to the technical problems discussed above by monitoring biometric parameters and device parameters of a user device to detect eSIM-related fraudulent attacks from malicious user devices. Further, the system performs remedy operations in response to detecting malicious activities.

Conventional technologies are not configured to provide a reliable and efficient solution for detecting eSIM-related fraudulent attacks. Conventional technologies are not configured to identify eSIM-related fraudulent attacks. Specifically, the conventional technologies are retroactive-meaning that after the attack has done its intended damage to compromise network security and data security, eSIM-related fraudulent attacks are detected and addressed. Conventional technologies suffer from several drawbacks. For example, because conventional technologies are retroactive, the security of network data (e.g., network carrier information) and sensitive information associated with an eSIM profile (e.g., phone number of the user device included in an eSIM profile) of the user device is already compromised by the attack. The sensitive information that is stolen by bad actors (e.g., hackers) can lead to security breaches, identity theft, and unauthorized access to confidential and sensitive information held by an underlying entity associated with the user. By controlling the network carrier information or phone number of the user device, bad actors (e.g., hackers) can intercept SMS messages containing one-time password (OTP) codes and use them to unlock accounts or bypass security measures (e.g., multi-factor authentication security). Further, bad actors may even incorrectly route calls and data sessions.

Another example is mass eSIM-related fraudulent attacks (i.e., in large numbers) that can overload the authentication and provisioning of servers, causing service degradation and/or network outages for a cellular carrier. Such mass eSIM-related fraudulent attacks can lead to network resource depletion (because of increased network load), which increases network latency associated with performing, for example, operations (e.g., cellular data-related operations) by legitimate user devices. These operations may include, for example, voice calls, video calls, and data transmission (files, pictures, videos, etc.) by legitimate user devices. This increase in network latency associated with operations results in the slower processing of network operations, resulting in network traffic bottlenecks. Network traffic bottlenecks may result in the queuing of operations in an operations queue, which can have several negative effects on overall network performance. For example, when each operation in an operations queue takes longer to complete due to high latency, the total time required to process all the operations within the operations queue increases. This directly affects the network's ability to process and transfer data efficiently, leading to slower overall system performance. Higher latency reduces throughput, which is the amount of data transmitted across the network in a given time period. This occurs because each operation takes longer to complete, resulting in fewer tasks being processed in the same amount of time. Higher latency associated with performing the operations also results in inefficient use of computing resources in the network. For example, high latency can lead to inefficient use of network resources. For instance, when high latency delays the execution time of operations, systems may remain idle while waiting for responses, leading to poor utilization of resources like CPU, memory, and bandwidth. In addition, when operations with high latency stack up or accumulate due to delays, they can create queues at intermediate network devices like routers, switches, and firewalls. This results in congestion of the network devices, thus lowering the performance of these devices. Also, when latency increases, applications and servers may be forced to wait longer for responses from external systems or databases. This added delay can lead to increased load on the system, as operations back up while waiting for network responses, reducing the efficiency and performance of a cellular network.

Embodiments of the present disclosure provide several practical applications and technical advantages that provide solutions to the problems discussed above in relation to conventional computing systems and networks. For example, the disclosed system and methods provide the practical application of proactively monitoring an eSIM of a user device for fraudulent attacks from malicious user devices based on monitoring biometric parameters and device parameters of a user device.

In some embodiments, a system for detecting eSIM-related fraudulent attacks from malicious user devices includes a memory operably coupled with a processor. The memory is configured to store an artificial intelligence (AI) algorithm, a plurality of biometric parameters associated with a first user of a first user device, and a plurality of device parameters associated with the first user device. The AI algorithm is trained to generate a baseline user profile associated with the first user of the first user based on the plurality of biometric parameters and the plurality of device parameters. Further, the processor is configured to receive an eSIM (embedded Subscriber Identity Module) monitoring request from the first user device, wherein the eSIM monitoring request comprises a user registration credential associated with the first user of the first user device. The processor is further configured to verify the received user registration credential matches a first user credential stored in a user profile of the first user.

The processor is configured to initiate monitoring of an eSIM of the first user device and, in response to initiating the monitoring of the eSIM of the first user device in response to verifying that the received user registration credential matches the stored first user credential. The processor further is configured to collect and store a plurality of eSIM configuration parameters associated with the eSIM of the first user device. The plurality of eSIM configuration parameters includes a first eSIM configuration parameter. The processor further is configured to collect the plurality of biometric parameters associated with the first user of the first user device. The plurality of biometric parameters includes a first biometric parameter. The processor collects the plurality of device parameters associated with the first user device. The plurality of device parameters includes a first device parameter.

The processor further is configured to execute the AI algorithm using the collected plurality of biometric parameters and the plurality of device parameters as input. The AI algorithm is configured to generate the baseline user profile associated with the first user device as output. The baseline user profile stores a first baseline value associated with the first biometric parameter and a second baseline value associated with the first device parameter.

The processor is configured to receive an eSIM modification request from a second user device, wherein the eSIM modification request is a request to transfer the first eSIM configuration parameter associated with the eSIM onto the second user device. The processor further is configured to collect a second plurality of biometric parameters associated with the second user device in response to receiving the eSIM modification request. The second plurality of biometric parameters includes a second biometric parameter. The processor further is configured to collect a second plurality of device parameters associated with the second user device. The second plurality of device parameters includes a second device parameter.

The processor further is configured to compare the second biometric parameter with the first baseline value associated with the first biometric parameter and determine if the second biometric parameter exceeds the first baseline value based on the comparison. The processor determines that the second biometric parameter is a first suspicious parameter. The first suspicious parameter is assigned a first value in response to determining that the second biometric parameter does not exceed the first baseline value. The processor further compares the second device parameter with the second baseline value associated with the first device parameter and determines if the second device parameter exceeds the second baseline value based on the comparison. The processor further determines that the second device parameter is a second suspicious parameter in response to determining that the second device parameter does not exceed the second baseline value. The second suspicious parameter is assigned a second value. The processor further generates an average value based on the first value and the second value and determines if the average value exceeds a threshold value. The processor in response to determining that the average value does not exceed a threshold value determines that the second user device is a malicious user device and denies the eSIM modification request from the second user device and transmits a suspicious activity alert to the first user device and a cellular network carrier.

By proactively identifying suspicious activities associated eSIM fraud and thus, the disclosed system and method reduces or avoids sensitive information to be stolen by bad actors (e.g., hackers) that can lead to security breaches, identity theft, and unauthorized access to confidential and sensitive information held by an underlying entity associated with the user. Further, by controlling the network carrier information or phone number of the user device, bad actors (e.g., hackers) cannot use them to unlock accounts or bypass security measures (e.g., multi-factor authentication security).

Additionally, mass eSIM-related fraudulent attacks are evaded and thus reducing or avoiding delays associated with cellular data-related operations and thus reduces overall latency in the computing network. Lowering latency associated with performing cellular data-related operations in a computing network can significantly improve network performance and computing performance in several ways and result in several technical advantages. For example, lower latency means cellular data-related operations are completed more quickly. This results in faster processing and data exchange across the network. Lower latency increases throughput of the network and user devices connected to the network. Since each operation in a sequence takes less time to complete, more operations can be processed in the same amount of time, resulting in higher throughput. With reduced latency, network and server resources are used more efficiently. Servers spend less time waiting for responses from other systems and can focus on processing operations more rapidly, leading to better resource utilization. Lower latency also reduces the time spent waiting in queues for resources or data. This minimizes the chance of congestion or backlogs at network devices (e.g., routers, switches) or servers. As a result, data flows more freely through the network. In addition, reducing latency helps optimize bandwidth by allowing data to flow more efficiently. When cellular data-related operations are completed more quickly, less bandwidth is wasted on waiting for data to be acknowledged or retransmitted, and the network can handle higher volumes of traffic.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with an embodiment of the present disclosure;

FIG. 2A illustrates a baseline user profile associated with biometric parameters, in accordance with one or more embodiments of the present disclosure;

FIG. 2B illustrates a baseline user profile associated with device parameters, in accordance with one or more embodiments of the present disclosure; and

FIGS. 3A-3B illustrates an example flowchart of a method of the system of FIG. 1 for detecting eSIM-related fraudulent attacks from malicious user devices.

### DETAILED DESCRIPTION OF THE DRAWINGS

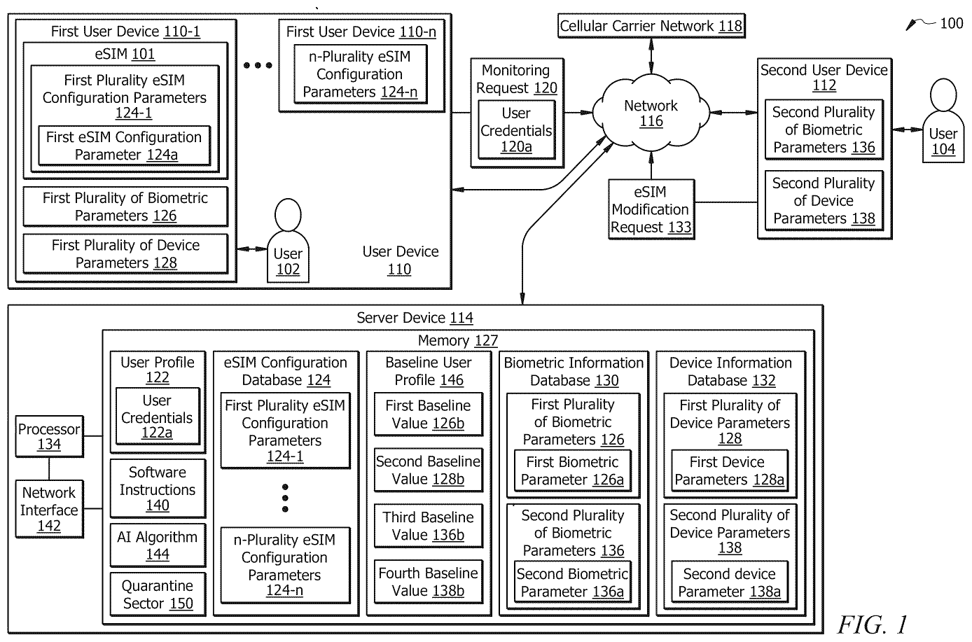

As described above, conventional technologies fail to detect eSIM-related fraudulent attacks. Embodiments of the present disclosure and its advantages may be understood by referring to FIGS. 1-3B. FIGS. 1-3B, which are used to describe systems and methods for detecting eSIM-related fraudulent attacks from malicious user devices, according to some embodiments.

### System Overview

FIG. 1 is a schematic diagram of a system 100, in accordance with certain embodiments of the present disclosure. As shown, system 100 includes a plurality of first user devices 110-1 to 110-n, a second user device 112, a server device 114, and a cellular carrier network 118, operably connected to one another via a network 116. Network 116 enables communication among the components of the system 100. The plurality of first user devices 110-1 to 110-n are collectively or individually referred to as first user device 110. In general, system 100 detects eSIM-related fraudulent attacks from malicious user devices (e.g., second user device 112).

### System Components

### First User Device & Second User Device

System 100 includes a plurality of first user devices 110-1 to 110-n, which are collectively referred to as first user device 110. For example, first user device 110-1 includes an eSIM 101, and the eSIM 101 includes a first plurality of eSIM configuration parameters 124-1. The first plurality of eSIM configuration parameters 124-1 includes a first eSIM configuration parameter 124a (e.g., a phone number associated with the eSIM 101).

Further, system 100 includes a second user device 112, although a plurality of second user devices 112 may also be included. The first user devices 110-1 to 110-n and second user device 112 may generally be any device configured to process data and communicate with other devices. The first user devices 110-1 to 110-n and second user device 112 may also include, but are not limited to, a personal computer, a desktop computer, a workstation, a server, a laptop, a tablet computer, a mobile phone (such as a smartphone), an Internet-of-Things (IoT) device, a wearable computing device, smart glasses, smart watches or bracelets, phablets, other smart devices, devices configured for wired or wireless RF (Radio Frequency) communication, or any other suitable type of device. The first user devices 110-1 to 110-n and second user device 112 may include a user interface, such as a display, a microphone, a camera, a keypad, or other appropriate equipment usable by a user (e.g., user 102 and user 104).

eSIM Configuration Parameters

The eSIM 101 of the first user device 110-1 is utilized by the first user device 110-1 to connect with the cellular carrier network 118 to perform cellular operations, such as make phone calls, video calls, messaging service, cellular data services, etc. The eSIM 101 includes eSIM configuration parameters 124-1. The eSIM configuration parameters 124-1 include a phone number associated with the eSIM 101 (i.e., a first eSIM configuration parameter 124a), a carrier URL (Uniform Resource Locator), SM-DP+server address (Subscription Manager Data Preparation Address), a data roaming status indicator, and/or a network selection indicator.

For example, eSIM 101 of the first user device 110-1 is assigned the phone number to perform cellular operations using the cellular carrier network 118, a carrier URL (Uniform Resource Locator) is the URL for a server associated with the eSIM 101 at the cellular carrier network 118, SM-DP+ server address (Subscription Manager Data Preparation Address) is the address associated with a server that manages the eSIM 101 at the cellular carrier network 118, a data roaming status indicator when turned ON allows eSIM 101 to access other cellular carrier networks when the cellular carrier network 118 is not available to perform cellular operations, a network selection indicator indicates if the eSIM 101 can automatically select a cellular carrier network or if it is selected manually.

### Network

Network 116, in general, may be a wide area network (WAN), a personal area network (PAN), a cellular network (e.g., 3G, 4G or 5G), or any other technology that allows devices to communicate electronically with other devices. In one or more embodiments, network 116 may be the Internet. The network 116 may be configured to support any suitable type of communication protocol, as would be appreciated by one of ordinary skills in the art.

### Server Device

The server device 114 includes a processor 134 in signal communication with a memory 127 and a network interface 142. Memory 127 stores software instructions 140 that, when executed by processor 134, cause processor 134 to perform one or more operations of the server device 114 described herein.

### Network Interface

Network interface 142 is configured to enable wired and/or wireless communications. The network interface 142 may be configured to communicate data between the server device 114 and first user devices 110-1 to 110-n, second user device 112, and other systems, domains, or devices. For example, the network interface 142 may include an NFC interface, a Bluetooth® interface, a Zigbee® interface, a Z-wave® interface, a radio-frequency identification (RFID®) interface, a WIFI® interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 134 may be configured to send and receive data using the network interface 142. The network interface 142 may be configured to use any suitable type of communication protocol.

### Memory

The memory 127 may be volatile or non-volatile and may comprise read-only memory (ROM), random-access memory (RAM), ternary content-addressable memory (TCAM), dynamic random-access memory (DRAM), and static random-access memory (SRAM). The memory 127 may include one or more of a local database, a cloud database, a network-attached storage (NAS), etc. The memory 127 comprises one or more disks, tape drives, or solid-state drives, and may be used as an over-flow data storage device, to store programs when such programs are selected for execution, and to store instructions and data that are read during program execution. The memory 127 may store any of the information described in FIGS. 1-3B along with any other data, instructions, logic, rules, or code operable to implement the function(s) described herein when executed by processor 134. For example, the memory 127 may store an eSIM configuration database 124, a biometric information database 130, a device information database 132, a baseline user profile 146, user profile 122, quarantine sector 150, software instructions 140, artificial intelligence (AI) algorithm 144, and/or any other data or instructions. The software instructions 140 may include any suitable set of instructions, logic, rules, or code operable to execute the processor 134 and perform the functions described herein, such as some or all of those described in FIGS. 1-3B.

Receive eSIM Monitoring Request

Processor 134 of server device 114 receives an eSIM monitoring request 120, including user credentials 120a from the first user device 110-1. The user credentials 120a may include a password, username, or any other authentication data. The eSIM monitoring request 120 is a request to initiate monitoring of the eSIM 101 associated with first user device 110-1 for fraudulent attacks.

Processor 134 determines if the received user credentials 120a match with user credentials 122a stored in the user profile 122. The user profile 122 stores user credentials 122a previously collected as part of a registration process from first user device 110-1. Upon determining that the user credentials 120a match with stored user credentials 122a, processor 134 determines that first user device 110-1 is successfully verified. Upon successfully verifying the received first user device 110-1, the processor 134 initiates monitoring the eSIM 101 of first user device 110-1 for fraudulent attacks from malicious user devices. The processor 134 initiates monitoring of the eSIM 101 by collecting and storing a plurality of eSIM configuration parameters 124-1 associated with the eSIM 101 of the first user device 110-1. The plurality of eSIM configuration parameters 124-1 includes a first eSIM configuration parameter 124a (e.g., a phone number associated with the eSIM 101).

### Collect First Biometric Parameters and First Device Parameters From First User Device

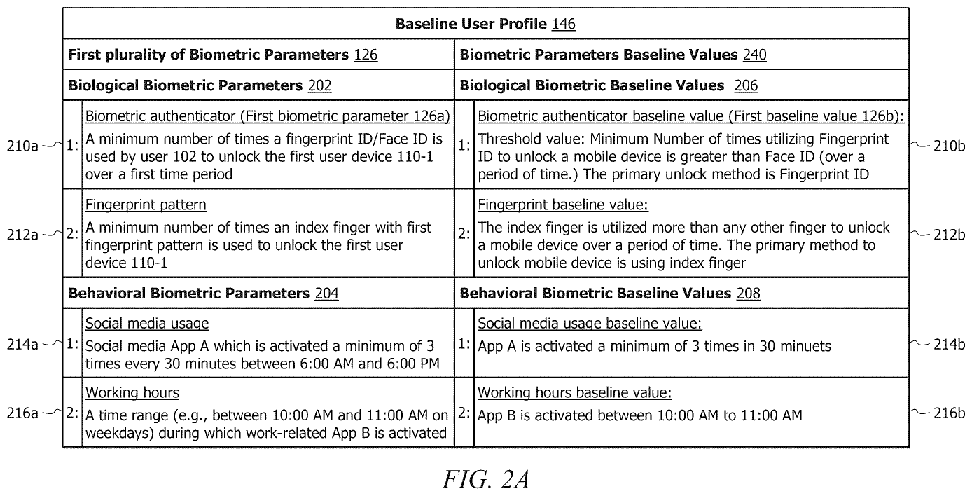

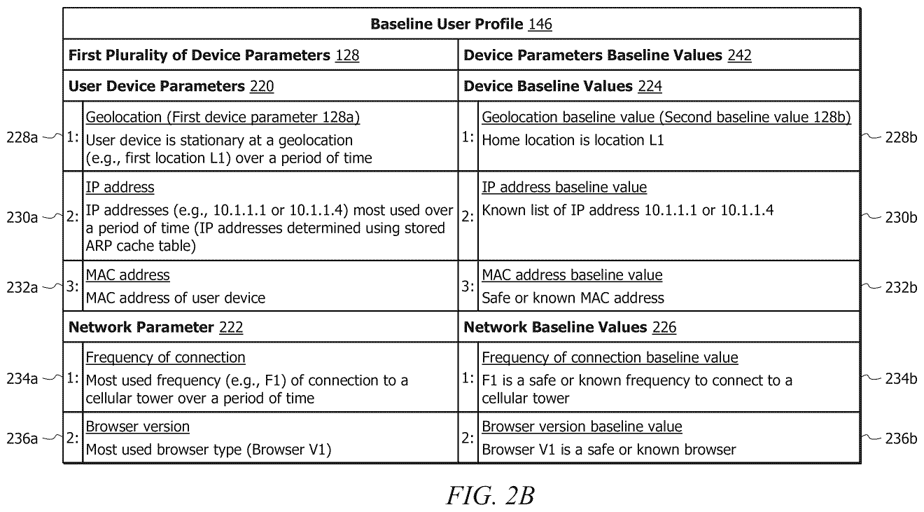

Processor 134 is configured to collect a first plurality of biometric parameters 126 associated with user 102 of the first user device 110-1. The first plurality of biometric parameters 126 includes, with reference to FIG. 2A, biological biometric parameters 202 and behavioral biometric parameters 204. The biological biometric parameters 202 include, for example, a biometric authenticator 210a (i.e., Fingerprint ID or Face ID is used to unlock the first user device 110-1) and/or Fingerprint pattern 212a (i.e., an index fingerprint (1^{st} fingerprint pattern) or a thumb fingerprint (2^{nd} fingerprint pattern) used to unlock the first user device 110-1). The behavioral biometric parameters 204 include, for example, social media usage 214a, and/or working hours 216a.

In an embodiment, biometric authenticator 210a (also referred to as first biometric parameter 126a) may include a minimum number of times a fingerprint ID is used by user 102 to unlock the first user device 110-1 over a first time period, for example, a minimum of 10 times in 15 minutes. In an embodiment, a minimum number of times a Face ID is used to unlock the first user device 110-1 over the first time period is, for example, a minimum of 1 time in 15 minutes. In an embodiment, fingerprint pattern 212a may include a minimum number of times an index finger with 1^{st} fingerprint pattern is used to unlock first user device 110-1 and a minimum number of times a thumb finger with 2nd fingerprint pattern is used to unlock first user device 110-1.

In an embodiment, social media usage 214a includes a minimum amount of time an application is activated (i.e., used or opened) on the first user device 110-1. An example of social media usage 214a is a social media App A which is opened a minimum of 3 times every 30 minutes between 6:00 AM and 6:00 PM. In an embodiment, working hours 216a includes a time range during which work-related App B is activated (i.e., used or opened) on the first user device 110-1. An example of working hours 216 a is a time range (e.g., between 10:00 AM and 11:00 AM on weekdays) during which work-related App B is activated (i.e., used or opened).

Processor 134 is configured to collect a first plurality of device parameters 128 associated with the first user device 110-1. The first plurality of device parameters 128 includes user device parameters 220 and network parameters 222. User device parameters 220 include, for example, geolocation 228a (also referred to as first device parameters 128a), IP (internet protocol) address 230a, and/or MAC (Media Access Control) address 232a. The IP address 230a and the MAC address 232a are stored in an ARP (Address Resolution Protocol) cache table. The network parameters 222 include, for example, a frequency of connection 234a and/or browser version 236a.

In an embodiment, the geolocation 228a information may be determined by utilizing a global positioning system (GPS) component of the first user device 110-1. The geolocation 228a may include GPS coordinates, which are usually expressed as a combination of latitude and longitude. The geolocation 228a, for example, when the first user device 110-1 is stationary (between 6:00 PM to 8:00 AM) at a geolocation (e.g., a first location L1) over a period of time (e.g., 7 days). The ARP cache table is an entry list of IP addresses 230a and their corresponding MAC addresses 232a. For example, once a MAC address 232a and IP address 230a pair are learned (upon an initial communication), then both the MAC address 232a and the corresponding IP address 230a are stored in the ARP cache table. For the first user device 110-1, the ARP cache table stores all the IP addresses 230a and the corresponding MAC address 232a it communicates.

In an embodiment, the frequency of connection 234a is determined by the most used frequency (e.g., F1) that user device 110-1 utilizes to communicate with cellular carrier network 118. User device 110-1 when at a home location L1 may be utilizing frequency F1 to connect with the cellular carrier network 118 over a period of time (7 days); thus, frequency F1 is determined as the most used frequency utilized to communicate with cellular carrier network 118. Browser version 236a is a web browser application on first user device 110-1 that is activated (used or opened) to browse for information over the internet.

### Baseline Profile (FIG. 2A-2B)

The collected first plurality of biometric parameters 126 and the first plurality of device parameters 128 of the first user device 110-1 are input into artificial intelligence (AI) algorithm 144. The AI algorithm 144 is configured to generate a baseline user profile 146 associated with the first user device 110-1 as output. The baseline user profile 146 stores biometric parameter baseline values 240 and device parameters baseline values 242. The biometric parameter baseline values 240 include biological biometric baseline values 206 associated with biological biometric parameters 202 and behavioral biometric baseline values 208 associated with behavioral biometric parameters 204. The device parameters baseline values 242 include device baseline values 224 and network baseline values 226.

For example, biological biometric baseline values 206 include biometric authenticator baseline value 210b (also referred to as a first baseline value 126b) associated with the first biometric parameter 126a and a second baseline value associated with the first device parameter. Further, device baseline value 224 includes geolocation baseline value 228b (also referred to as a second baseline value 128b) associated with the first device parameter 128a.

In an embodiment, the baseline profile 146 is generated based only on the collected first plurality of biometric parameters 126 without the first plurality of device parameters 128 of the first user device 110-1. In an embodiment, the baseline profile 146 is generated based only on the first plurality of device parameters 128 without the collected first plurality of biometric parameters 126.

The collected first plurality of biometric parameters 126 and the first plurality of device parameters 128 of the first user device 110-1 are input into artificial intelligence (AI) algorithm 144. The AI algorithm 144 is configured to generate a baseline user profile 146 associated with the first user device 110-1 as output. The baseline user profile 146 stores biometric parameter baseline values 240 and device parameters baseline values 242. The biometric parameter baseline values 240 include biological biometric baseline values 206 associated with biological biometric parameters 202 and behavioral biometric baseline values 208 associated with behavioral biometric parameters 204. The device parameters baseline values 242 include device baseline values 224 and network baseline values 226.

### AI Algorithm

The artificial intelligence (AI) algorithm 144 is trained using two data sets. The first data set is collected and includes a dataset of the plurality of biometric parameters and device parameters from multiple user devices. Annotations are applied to each of the biometric parameters and device parameters included in the first data set. The annotations indicate those biometric parameters and device parameters that exceed a threshold number (e.g., a minimum number of times a Fingerprint ID/Face ID is used) to detect a baseline value. A first training set is created, which includes the annotated biometric parameters and device parameters and non-annotated biometric parameters and device parameters. The AI algorithm 144 is trained using the annotated biometric parameters and device parameters and non-annotated biometric parameters and device parameters to identify those biometric parameters and device parameters that exceed the threshold number to detect a baseline value. A second training set is created for a second stage of training comprising the first training set and those biometric parameters and device parameters that are incorrectly detected to exceed the threshold number after the first stage of training. The AI algorithm 144 is re-trained in a second stage using the second training set to generate a trained AI algorithm 144 to detect baseline values.

The AI algorithm 144 may include a support vector machine, machine learning, neural network, random forest, a large language model (LLM) algorithm, deep learning algorithm, k-means clustering, Tree-based algorithm, Random Forest algorithm, convolutional neural network (CNN), deep neural network (DNN), recurrent neural network (RNN), Naïve Bayes classification, etc. In some embodiments, the AI algorithm 144 may include a data processing machine learning algorithm that is configured to detect baseline values. The AI algorithm 144 may be implemented by supervised, semi-supervised, and/or unsupervised machine learning. In another embodiment, processor 134 executes the AI algorithms 144, to perform one or more operations of detecting baseline values. In another embodiment, processor 134 executes software instructions 140 and is configured to detect the baseline values without utilizing AI algorithm 144.

In an embodiment, processor 134 executes AI algorithm 144 with the first biometric parameter 126a (i.e., biometric authenticator 210a e.g., Fingerprint ID or Face ID) as input. AI algorithm 144 analyzes the minimum number of times biometric authenticator 210a, such as Fingerprint ID or Face ID is used to unlock the first user device 110-1. For example, AI algorithm 144 determines that the minimum number of times a fingerprint ID (e.g., 10 times in 1 hour) used to unlock the first user device 110-1 is greater than the minimum number of times a Face ID (e.g., 2 times in 1 hour) used to unlock the first user device 110-1. Accordingly, for the first biometric parameter 126a input to the AI algorithm 144, the AI algorithm 144 outputs the first baseline value 126b (i.e., fingerprint ID has been used a minimum of 10 times in 1 hour) to unlock the first user device 110-1. Thus, AI algorithm 144 determines the primary method to unlock the first user device 110-1 is by Fingerprint ID. The first baseline value 126b is also referred to as the biometric authenticator baseline value 210b.

Similarly, when processor 134 executes AI algorithm 144 with fingerprint pattern 212a as input, AI algorithm 144 outputs a fingerprint baseline value 212b (i.e., the index finger is the primary method to unlock first user device 110-1). The AI algorithm 144 determines the minimum number of times an index finger with a first fingerprint pattern used to unlock the first user device 110-1 is more than the minimum number of times a thumb finger (or any other finger) with a second fingerprint pattern is used to unlock the first user device 110-1.

In an embodiment, processor 134 executes AI algorithm 144 with the social media usage 214a (i.e., Social media App A is activated a minimum of 3 times in every 30 minutes between 6:00 AM and 6:00 PM.) The AI algorithm 144 is configured to generate a corresponding social media baseline value 214b. The social media baseline value 214b is that App A has to be activated (opened/used) a minimum of 3 times in 30 minutes. Similarly, processor 134 executes AI algorithm 144 with the working hours 216a (i.e., a time range (between 10:00 AM and 11:00 AM) during which work-related App B is activated). The AI algorithm 144 is configured to generate a corresponding working hours baseline value 216b. The working hours baseline value 216b is App B has to be activated (opened/used) between 10:00 AM and 11:00 AM.

In an embodiment, processor 134 executes AI algorithm 144 with a first device parameter 128a (geolocation 228a) as input. The AI algorithm 144 analyzes the geolocation 228a, for example, and determines that the first user device 110-1 is stationary (between 6:00 PM to 8:00 AM) at a geolocation (e.g., a first location L1) over a period of time (e.g., 7 days) in comparison to all the other locations first user device 110-1 travels. The AI algorithm 144 determines since the first user device 110-1 is stationary at the first location L1 over a period of time, the first location L1 is the home location of the first user device 110-1. Accordingly, for the first device parameter 128a (geolocation 228a) as input, AI algorithm 144 outputs the second baseline value 128b (i.e., geolocation baseline value 228b, e.g. first location L1). Thus, AI algorithm 144 identifies the first location L1, as the Home location of the first user device 110-1. The second baseline value 128b is also referred to as the geolocation baseline value 228b.

Similarly, when processor 134 executes AI algorithm 144 with IP address 230a and MAC address 232a as input, AI algorithm 144 outputs IP address baseline value 230b (i.e., a known list of IP addresses) and MAC address baseline value (i.e. known MAC addresses), respectively. For the IP address 230a AI algorithm 144 determines the most used IP addresses by accessing the ARP cache table and further also determines the MAC address 232a corresponding to the IP address 230a stored in the ARP cache table. Thus, AI algorithm 144 outputs the IP address baseline value 230b and MAC address baseline value 232b.

In an embodiment, when processor 134 executes AI algorithm 144 with the frequency of connection 234a, including the most used frequency (e.g., F1), then the AI algorithm 144 determines that user device 110-1 when at a home location L1 is utilizing frequency F1 to connect with the cellular carrier network 118 over a period of time (7 days); thus, frequency of connection baseline value 234b is frequency F1 is determined as the most used frequency utilized to communicate with cellular carrier network 118. Similarly, when processor 134 determines Browser V1 is a safe or known browser based on determining that user device 110-1 utilizes browser V1 the most.

Receive eSIM Modification Request

Next, processor 134 is configured to receive an eSIM modification request 133 from a second user device 112. For example, the eSIM modification request 133 is a request to transfer a phone number associated with the eSIM 101 of the first user device 110-1 onto the second user device 112. In an embodiment, user 104 of the second user device 112 may be a bad actor (i.e., a malicious user device) that is impersonating user 102 of the first user device 110-1 and transmits eSIM modification request 133 to transfer first eSIM configuration parameter 124a (e.g., a phone number associated with the eSIM 101) of the first user device 110-1 onto the second user device 112 to perform malicious activities (e.g., access sensitive information held by an underlying entity associated with the user 102).

In an embodiment, the user 102 and user 104 are the same users. For example, user 102 may have purchased a new device (e.g., second user device 112) and would like to use the second user device 112 instead of the first user device 110-1. In this situation, user 102 transmits the eSIM modification request 133, which is a request to transfer the first eSIM configuration parameter 124a (e.g., a phone number associated with the eSIM 101) of the first user device 110-1 onto the second user device 112.

### Collect Second Biometric Parameters From the Second User Device and Assign a First Value

In response to receiving the eSIM modification request 133, the processor 134 is configured to collect a second plurality of biometric parameters 136 associated with the second user device 112. For example, when a second biometric parameter 136a of the second plurality biometric parameter 136 is a biometric authenticator 136a (e.g., Fingerprint ID or Face ID). The second biometric parameter 136a is interchangeably referred to as biometric authenticator 136a. The processor 134 analyzes the minimum number of times biometric authenticator 136a, such as Fingerprint ID or Face ID, is used to unlock the second user device 112. The processor 134 determines for the second biometric parameter 136a (i.e., associated with the second user device 112) the minimum number of times a fingerprint ID is used (e.g., 1 time in the past 1 hour) by the second user device 112 is less than (does not exceed) the first baseline value 126b (i.e., fingerprint ID is used 10 times in 1 hour of the biometric authenticator 136a) associated with the first user device 110-1. In response to determining that the second biometric parameter 136a does not exceed the first baseline value 126b, processor 134 determines that the second biometric parameter 136a associated with the second user device 112 is a first suspicious parameter.

Processor 134 assigns the first suspicious parameter a score of 25 (i.e. a first value is 25), based on the first baseline value 126b (i.e., fingerprint ID is used a minimum of 10 times in 1 hour). Specifically, for the second biometric parameter 136a associated with the second user device 112, for example, processor 134 determines if the minimum number of times a fingerprint ID is used is less than half of the minimum number of times a fingerprint ID is used in the first baseline value 126b (i.e. when the first baseline value is minimum of 10 times in 1 hour and the second biometric parameter 136a is less than 5 times in 1 hour i.e., between a range of 0-5 times in 1 hour) then a score of 25 is assigned to the first suspicious parameter.

In another embodiment, when processor 134 determines if the minimum number of times a fingerprint ID is used for the second biometric parameter 136a associated with the second user device 112 is, for example, more than half of the minimum number of times a fingerprint ID is used in the first baseline value 126b (i.e. when the first baseline value is 10 times in 1 hour and the second biometric parameter 136a is more than 5 times in 1 hour i.e., between a range of 5-10 times in 1 hour) then a score of 50 is assigned to the first suspicious parameter. In another embodiment, when processor 134 determines if the minimum number of times a fingerprint ID is used for the second biometric parameter 136a associated with the second user device 112 is, for example, more than the minimum number of times a fingerprint ID is used in the first baseline value 126b (i.e. when the first baseline value is 10 times in 1 hour and the second biometric parameter 136a is more than 10 times in 1 hour, i.e., for example, 14 times in 1 hour) then a score of 90 is assigned to the first suspicious parameter.

### Collect Second Device Parameters From the Second User Device and Assign a Second Value

Next, processor 134 collects a second plurality of device parameters 138 associated with the second user device 112. The second plurality of device parameters 138 includes a second device parameter 138a and the second device parameter 138a is geolocation information of the second user device 112. Specifically, in response to the eSIM modification request 133 the processor 134 determines the geolocation information of the second user device 112. For example, when processor 134 identifies the geolocation of the second user device 112 is for example, a second location L2. The processor 134 determines if the second device parameter 138a (i.e., geolocation associated with the second user device 112) is within a threshold distance (e.g., 150 miles) from the second baseline value 128b (i.e., first location L1) of the associated with the first user device 110-1.

When the processor 134 determines that the second device parameter 138a (i.e., geolocation associated with the second user device 112) is second location L2 which is not within the threshold distance (e.g., 150 miles) from the second baseline value 128b (i.e., first location L1) of the associated with the second user device 112, then processor 134 determines that the second device parameter 138a associated with the second user device 112 is a second suspicious parameter. Processor 134 assigns the second suspicious parameter a score of 50 (i.e., a second value is 50) based on the second baseline value 128b (i.e., first location L1). Specifically, when the geolocation associated with the second user device 112 (i.e., second location L2) is more than the first threshold distance (e.g., 150 miles) and less than a second threshold distance and (e.g., 500 miles) away from the second baseline value 128b (i.e., first location L1), then the processor 134 assigns a score of 50 to the second suspicious parameter.

In another embodiment, the processor 134 assigns the second suspicious parameter a score of 25 (i.e., a second value is 50) based on the second baseline value 128b (i.e., first location L1). Specifically, when the geolocation associated with the second user device 112 (i.e., second location L2) is more than a second threshold distance and (e.g., 500 miles) away from the second baseline value 128b (i.e., first location L1), then the processor 134 assigns a score of 25 to the second suspicious parameter.

In another embodiment, the processor 134 assigns the second suspicious parameter a score of 90 (i.e., a second value is 90) based on the second baseline value 128b (i.e., first location L1). Specifically, when the geolocation associated with the second user device 112 (i.e., second location L2) is less than the first threshold distance (e.g., 150 miles) from the second baseline value 128b (i.e., first location L1), then the processor 134 assigns a score of 90 to the second suspicious parameter.

Determine Average Value and eSIM Modification Request and Deny Request

Processor 134 then generates an average value based on an average of the first value (e.g., a score of 25) and the second value (score of 50). In this example, the average value is 37.5 (i.e., an average of the first value and the second value). Next, the processor 134 determines if this average value (e.g., 37.5), exceeds a threshold value of (e.g., 80, although any other threshold value may be included). In response to determining that the average value (e.g., 37.5) does not exceed the threshold value (e.g., 80), then processor 134 determines that the second user device 112 is a malicious user device, and thus, processor 134 denies the eSIM modification request 133 from the second user device 112. Further, the processor 134 then transmits a suspicious activity alert to the first user device 110-1 and a cellular carrier network 118. For example, the cellular carrier network 118 may be any cellular network, for example, 3G, 4G or 5G, or any other telecommunications network.

In an embodiment, processor 134 generates the average value based only on the collected first plurality of biometric parameters 126 without the first plurality of device parameters 128. In an embodiment, processor 134 generates the average value based only on the first plurality of device parameters 128 without the collected first plurality of biometric parameters 126.

In a certain embodiment, processor 134 is configured to collect a second plurality of device parameters 138 associated with the second user device 112, for example, the second plurality of device parameters 138 may include an IP address and MAC address associated with the second user device 112. Processor 134 is configured to compare the IP address and MAC address associated with the second user device 112 with the IP address baseline value 230b and MAC address baseline value 232b. When the IP address and/or the MAC address associated with the second user device 112 does not match (i.e. is different) with the IP address baseline value 230b and MAC address baseline value 232b, then processor 134 determines that the second user device 112 is a second suspicious parameter. Processor 134 assigns the second suspicious parameter a score of 50 (i.e., a second value is 50) to the IP address and MAC address (collected as part of the second plurality of device parameters 138) associated with the second user device 112. When the IP address and/or the MAC address associated with the second user device 112 does match (i.e. is the same) with the IP address baseline value 230b and MAC address baseline value 232b, then processor 134 determines that IP address and/or the MAC address associated with the second user device 112 is not a second suspicious parameter and assigns a score of 90 (e.g., a second value is 90).

In an embodiment, processor 134 is configured to collect a second plurality of device parameters 138 associated with the second user device 112, for example, the second plurality of device parameters 138 may include a frequency F2 for the second user device 112 to connect with the cellular carrier network 118. Processor 134 is configured to compare the frequency F2 associated with the second user device 112 with the frequency of connection baseline value 234b (i.e., frequency F1) associated with the first user device 110-1. When the frequency F2 associated with the second user device 112 does not match (i.e., is different) than the frequency of connection baseline value 234b (i.e., frequency F1) associated with the first user device 110-1, then processor 134 determines that the second user device 112 is a second suspicious parameter. Processor 134 assigns the second suspicious parameter a score of 50 (i.e., a second value is 50) to the frequency F2 associated with the second user device 112. When the frequency F2 associated with the second user device 112 does match (i.e., is the same), the frequency of connection baseline value 234b (i.e., frequency F1) associated with the first user device 110-1, then processor 134 determines that frequency F2 associated with the second user device 112 is not a second suspicious parameter and assigns a score of 90 (e.g., a second value is 90). Similarly, when the second plurality of device parameters 138 includes a browser version of VB2, then processor 134 determines if the baseline 236b Browser V1 is different than browser version VB2. When it is different, then browser VB2 associated with the second user device 112 is determined as a second suspicious parameter and a score of 50 is assigned (e.g., a first value is 50). When it is different, then browser VB2 associated with the second user 112 is not a second suspicious parameter and assigns a score of 90 (e.g., a second value is 90).

In an embodiment, when processor 134 then generates a first value (e.g., a score of 90) and the second value (score of 90). In this example, the average value is 90 (i.e., an average of the first value and the second value). Then, processor 134 determines that the average value (i.e., 90) exceeds the threshold value (e.g., 80), and thus processor 134 determines that the second user device 112 is not a malicious user device and allows the eSIM modification request 133 from the second user device 112. Next, processor 134 re-trains the AI algorithm 144, based on the collected second plurality of biometric parameters 136 and the collected second plurality of device parameters 138 associated with the second user device 112 as input, to generate an updated baseline user profile 146 associated with the first user device 110-1 as output.

Processor 134 in response to denying the eSIM modification request 133 from the second user device 112, transmits an identity verification request to the second user device 112. Identity verification request includes a request to provide a first biometric input from the second user device 112. In response to transmitting the identity verification request, receive the first biometric input from the second user device 112. Processor 134 compares the received first biometric input (e.g., a fingerprint FP1 associated with user 104 of the second user device 112) with a biometric parameter (e.g., Fingerprint pattern 212a) to determine if the received first biometric input (FP1) matches with the biometric parameter (e.g., Fingerprint pattern 212a). Processor 134 determines that the received first biometric input (e.g., FP1) matches with the biometric parameter (e.g., Fingerprint pattern 212a), then processor 134 allows the eSIM modification request 133 from the second user device 112 and transmits a successful eSIM modification request 133 notification to the first user device 110-1.

In an embodiment, if processor 134 determines that the second biometric parameter 136a does exceed the first baseline value 126b, generate a third value (e.g., 90), and in response to determining that the second device parameter 138a does exceed the second baseline value 128b, generate a fourth value (e.g., 90). Processor 134 then generates another average value (e.g., 90) based on the third value and fourth value. Processor 134 then determines when another average value (e.g., 90) exceeds the threshold value (e.g., 80), and thus determines that the second user device 112 is not a malicious user device and allows the eSIM modification request 133 from the second user device 112. Processor 134 then transmits a successful eSIM modification request 133 notification to the first user device 110-1.

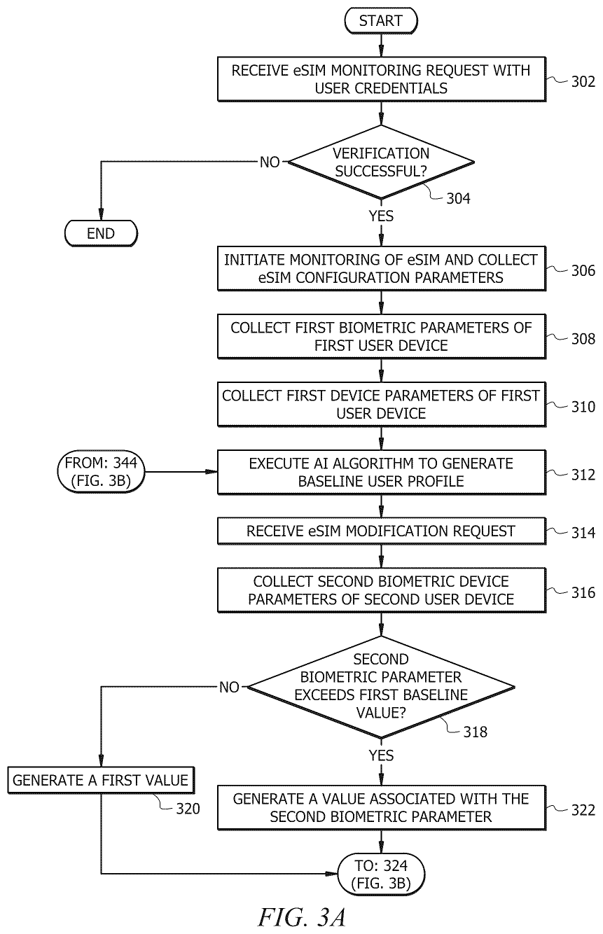

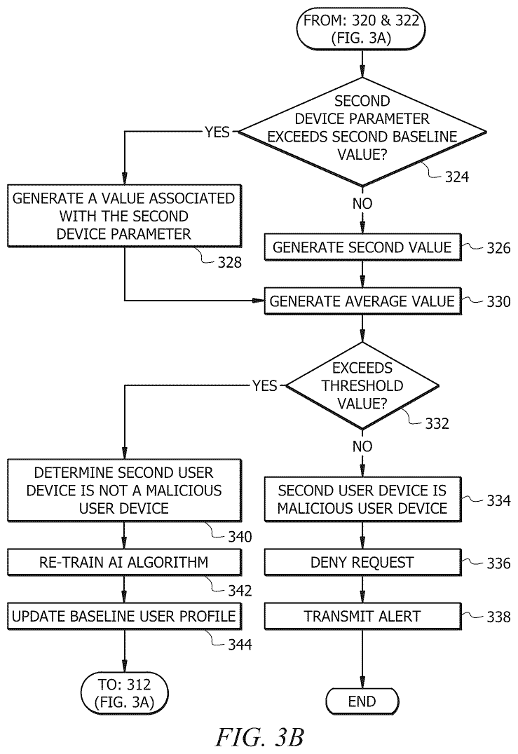

FIGS. 3A-3B illustrates an example flowchart of method 300 for detecting eSIM-related fraudulent attacks from malicious user devices, in accordance with an embodiment of the present disclosure. For example, one or more operations of method 300 may be implemented, at least in part, in the form of software instructions 140 of FIG. 1, stored on a tangible non-transitory machine-readable medium or a computer-readable medium (e.g., memory 127 of FIG. 1) that, when run by one or more processors (e.g., processor 134 of FIG. 1) may cause the one or more processors to perform operations of the method 300.

Referring to FIG. 3A, at operation 302, processor 134 of the server device 114 is configured to receive eSIM monitoring request 120, including user credentials 120a from the first user device 110-1. At operation 304, processor 134 determines if the received user credentials 120a match with user credentials 122a stored in the user profile 122. Upon determining that the user credentials 120a match with stored user credentials 122a, processor 134 determines that the first user device 110-1 is successfully verified, and the method proceeds to operation 306. Further back at operation 304, when the user credentials 120a do not match with the stored user credentials 122a, then the method ends here.

At operation 306, processor 134 initiates monitoring of the eSIM 101 by collecting and storing a plurality of eSIM configuration parameters 124-1 associated with the eSIM 101 of the first user device 110-1.

At operation 308, processor 134 collects a first plurality of biometric parameters 126 associated with user 102 of the first user device 110-1.

Next, at operation 310, processor 134 collects a first plurality of device parameters 128 associated with user 102 of the first user device 110-1.

At operation 312, processor 134 executes AI algorithm 144. The collected first plurality of biometric parameters 126 and the first plurality of device parameters 128 of the first user device 110-1 are input into an artificial intelligence (AI) algorithm 144, and the AI algorithm 144 is configured to generate a baseline user profile 146 associated with the first user device 110-1 as output.

At operation 314, processor 134 receives an eSIM modification request 133 from a second user device 112. At operation 316, processor 134 collects a second plurality of biometric parameters 136 and a second plurality of device parameters 138 associated with the second user device 112.

At operation 318, processor 134 determines if a second biometric parameter 136a exceeds the first baseline value 126b. In response to determining that the second biometric parameter 136a does not exceed the first baseline value 126b, the method proceeds to operation 320 and determines that the second biometric parameter 136a associated with the second user device 112 is a first suspicious parameter and generates a score (e.g., a first value is a score of 25) associated with the first suspicious parameter. In response to determining that the second biometric parameter 136a does exceed the first baseline value 126b, the method proceeds to operation 322, and processor 134 generates a score (i.e., a value associated with the biometric parameter 136a).

Referring to FIG. 3B, at operation 324, processor 134 determines if a second device parameter 138a exceeds the second baseline value 128b. In response to determining that the second device parameter 138a does not exceed the second baseline value 128b, the method proceeds to operation 326, and processor 134 determines that the second device parameter 138a associated with the second user device 112 is a second suspicious parameter and generates a score (e.g., a second value is a score of 50) associated with the second suspicious parameter. In response to determining that the second device parameter 138a does exceed the second baseline value 128b, the method proceeds to operation 328, and processor 134 generates a score (i.e., a value associated with the device parameter 138a).

At operation 330, processor 134 then generates an average value based on an average of the first value (e.g., a score of 25) and the second value (score of 50). In this example, the average value is 37.5 (i.e., an average of the first value and the second value).

At operation 332, processor 134 determines if this average value (e.g., 37.5), exceeds a threshold value of (e.g., 80, although any other threshold value may be included). In response to determining that the average value (e.g., 37.5) does not exceed the threshold value (e.g., 80), then method proceeds to operation 334. At operation 334, processor 134 determines that the second user device 112 is a malicious user device. At operation 336, processor 134 denies the eSIM modification request 133 from the second user device 112. At operation 338 the processor 134 then transmits a suspicious activity alert to the first user device 110-1 and a cellular carrier network 118.

Back at operation 340, in response to determining that the average value does exceed the threshold value, the method proceeds to operation 340. At operation 340 processor 134 determines that the second user device 112 is a not malicious user device. At operation 342, processor 134 re-trains the AI algorithm 144 based on the second plurality of biometric parameters 136 and the second plurality of device parameters 138. At operation 344, the method loops back to operation 344 to update the baseline user profile 146 based on the re-trained AI algorithm 144.

### Quarantine Sector

In an embodiment, the eSIM modification request 133 received from the second user device 112 may include malicious software codes (i.e., a malicious file). For example, the eSIM modification request 133 is a request to transfer the phone number associated with the eSIM 101 of the first user device 110-1 onto the second user device 112. The server device 114 may quarantine the eSIM modification request 133 in a quarantine sector 150 within the memory 127 of the server device 114. A quarantine sector 150 is a memory sector created by the server device 114 such that any request (including the eSIM modification request 133) stored in this quarantine sector 150 is not permitted or prevented from acting on files outside the quarantine sector 150. Thus, any malicious file included in the eSIM modification request 133 is isolated in the quarantine sector 150 and thus cannot harm or attack the rest of the components outside the quarantine sector 150. Once the eSIM modification request 133 is transferred into the quarantine sector 150, the server device 114 determines if the eSIM modification request 133 includes a malicious file based on performing a scan of the eSIM modification request 133. As part of the scan, the server device 114 accesses a database (stored within the quarantine sector 150) that includes known malicious software codes and determines if a software code (e.g., JSON (JavaScript Object Notation) code) of the received eSIM modification request 133 (e.g., a JSON file format) includes the known malicious software codes. The server device 114 identifies the known malicious software codes based on previously determined malicious operations performed by the known malicious software codes. If at least a part of the software code of the eSIM modification request 133 matches with any of the known malicious software codes, then the server device 114 mitigates any identified threat by deleting the malicious software code from the eSIM modification request 133 to generate a sanitized version of the eSIM modification request 133.

The sanitized version of the eSIM modification request 133 is then processed by the processor 134 of the server device 114 by collecting a second plurality of biometric parameters 136 and the second plurality of device parameters 138 associated with the second user device 112 to allow or deny the eSIM modification request 133 (as explained above). In this manner, malicious attacks are mitigated by physically isolating the eSIM modification request 133 onto the quarantine sector 150 and deleting the malicious software code from the eSIM modification request 133 to create a sanitized version of the eSIM modification request 133. Thus, by mitigating malware attacks before an attack takes place, the security of the server device 114 and information stored in the server device 114 is not compromised. Accordingly, the disclosed system provides a practical application and technical improvement for detecting malware threats and addresses and mitigating the malware threats before the malicious software code has a chance to infect the system.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

1. A system comprising:
a memory operable to store an artificial intelligence (AI) algorithm, a plurality of biometric parameters associated with a first user of a first user device, and a plurality of device parameters associated with the first user device, wherein the AI algorithm is trained to generate a baseline user profile associated with the first user of the first user based on the plurality of biometric parameters and the plurality of device parameters; and
a processor operably coupled to the memory and configured to:
receive an eSIM (embedded Subscriber Identity Module) monitoring request from the first user device, wherein the eSIM monitoring request comprises a user registration credential associated with the first user of the first user device;
verify the received user registration credential matches a first user credential stored in a user profile of the first user;
in response to verifying that the received user registration credential matches the stored first user credential, initiate monitoring of an eSIM of the first user device and, in response to initiating the monitoring of the eSIM of the first user device:
collect and store a plurality of eSIM configuration parameters associated with the eSIM of the first user device, wherein the plurality of eSIM configuration parameters includes a first eSIM configuration parameter;
collect the plurality of biometric parameters associated with the first user of the first user device, wherein the plurality of biometric parameters includes a first biometric parameter;
collect the plurality of device parameters associated with the first user device, wherein the plurality of device parameters includes a first device parameter; and
execute the AI algorithm using the collected plurality of biometric parameters and the plurality of device parameters as input, wherein the AI algorithm is configured to generate the baseline user profile associated with the first user device as output, wherein the baseline user profile stores a first baseline value associated with the first biometric parameter, a second baseline value associated with the first device parameter;
receive an eSIM modification request from a second user device, wherein the eSIM modification request is a request to transfer the first eSIM configuration parameter associated with the eSIM onto the second user device; and
in response to receiving the eSIM modification request:
collect a second plurality of biometric parameters associated with the second user device, wherein the second plurality of biometric parameters includes a second biometric parameter;
collect a second plurality of device parameters associated with the second user device, wherein the second plurality of device parameters includes a second device parameter;
compare the second biometric parameter with the first baseline value associated with the first biometric parameter and determine if the second biometric parameter exceeds the first baseline value based on the comparison;
in response to determining that the second biometric parameter does not exceed the first baseline value, determine that the second biometric parameter is a first suspicious parameter, wherein the first suspicious parameter is assigned a first value;
compare the second device parameter with the second baseline value associated with the first device parameter and determine if the second device parameter exceeds the second baseline value based on the comparison;
in response to determining that the second device parameter does not exceed the second baseline value, determine that the second device parameter is a second suspicious parameter, wherein the second suspicious parameter is assigned a second value;
generate an average value based on the first value and the second value;
determine if the average value exceeds a threshold value;
in response to determining that the average value does not exceed a threshold value, determine that the second user device is a malicious user device and deny the eSIM modification request from the second user device; and
transmit a suspicious activity alert to the first user device and a cellular network carrier.

2. The system of claim 1, wherein the processor is further configured to:
in response to determining that the average value exceeds the threshold value, determine that the second user device is not a malicious user device and allow the eSIM modification request from the second user device; and
re-train, the trained AI algorithm, based on the collected second plurality of biometric parameters and the collected second plurality of device parameters associated with the second user device as input, to generate an updated baseline user profile associated with the first user of the first user device as output.

3. The system of claim 1, wherein the processor is further configured to:
in response to denying the eSIM modification request from the second user device, transmit an identity verification request to the second user device, wherein the identity verification request includes a request to provide a first biometric input from the second user device;
in response to transmitting the identity verification request, receive the first biometric input from the second user device;
compare the received first biometric input with the first biometric parameter to determine if the received first biometric input matches with the first biometric parameter;
in response to determining that received first biometric input matches with the first biometric parameter, allow the eSIM modification request from the second user device; and
transmit a successful eSIM modification request notification to the first user device.

4. The system of claim 1, wherein the processor is further configured to:
in response to determining that the second biometric parameter does exceed the first baseline value, generate a third value;
in response to determining that the second device parameter does exceed the second baseline value, generate a fourth value; and
generate a second average value based on the third value and fourth value.

5. The system of claim 4, wherein the processor is further configured to:
in response to determining that the second average value exceeds the threshold value, determine that the second user device is not a malicious user device and allow the eSIM modification request from the second user device; and
transmit a successful eSIM modification request notification to the first user device.

6. The system of claim 1, wherein the plurality of eSIM configuration parameters comprises one or more of a phone number associated with the eSIM, a carrier URL (Uniform Resource Locator), SM-DP+ server address (Subscription Manager Data Preparation Address), a data roaming status indicator, and/or a network selection indicator.

7. The system of claim 6, wherein the eSIM modification request is a request to transfer the phone number associated with the eSIM onto the second user device.

8. A method comprising:
receiving an eSIM (embedded Subscriber Identity Module) monitoring request from a first user device, wherein the eSIM monitoring request comprises a user registration credential associated with a first user of the first user device;
verifying the received user registration credential matches a first user credential stored in a user profile of the first user;
in response to verifying that the received user registration credential matches the stored first user credential, initiating monitoring of an eSIM of the first user device and, in response to initiating the monitoring of the eSIM of the first user device:
collecting and storing a plurality of eSIM configuration parameters associated with the eSIM of the first user device, wherein the plurality of eSIM configuration parameters includes a first eSIM configuration parameter;
collecting a plurality of biometric parameters associated with the first user of the first user device, wherein the plurality of biometric parameters includes a first biometric parameter;
collecting a plurality of device parameters associated with the first user device, wherein the plurality of device parameters includes a first device parameter; and
executing an AI algorithm using the collected plurality of biometric parameters and the plurality of device parameters as input, wherein the AI algorithm is configured to generate a baseline user profile associated with the first user device as output, wherein the AI algorithm is trained to generate the baseline user profile associated with the first user of the first user based on the plurality of biometric parameters and the plurality of device parameters and wherein the baseline user profile stores a first baseline value associated with the first biometric parameter, a second baseline value associated with the first device parameter;
receiving an eSIM modification request from a second user device, wherein the eSIM modification request is a request to transfer the first eSIM configuration parameter associated with the eSIM onto the second user device; and
in response to receiving the eSIM modification request:
collecting a second plurality of biometric parameters associated with the second user device, wherein the second plurality of biometric parameters includes a second biometric parameter;
collecting a second plurality of device parameters associated with the second user device, wherein the second plurality of device parameters includes a second device parameter;
comparing the second biometric parameter with the first baseline value associated with the first biometric parameter and determine if the second biometric parameter exceeds the first baseline value based on the comparison;
in response to determining that the second biometric parameter does not exceed the first baseline value, determining that the second biometric parameter is a first suspicious parameter, wherein the first suspicious parameter is assigned a first value;
comparing the second device parameter with the second baseline value associated with the first device parameter and determine if the second device parameter exceeds the second baseline value based on the comparison;
in response to determining that the second device parameter does not exceed the second baseline value, determining that the second device parameter is a second suspicious parameter, wherein the second suspicious parameter is assigned a second value;
generating an average value based on the first value and the second value;
determining if the average value exceeds a threshold value;
in response to determining that the average value does not exceed a threshold value, determining that the second user device is a malicious user device and deny the eSIM modification request from the second user device; and
transmitting a suspicious activity alert to the first user device and a cellular network carrier.

9. The method of claim 8, further comprising:
in response to determining that the average value exceeds the threshold value, determining that the second user device is not a malicious user device and allow the eSIM modification request from the second user device; and
re-training, the trained AI algorithm, based on the collected second plurality of biometric parameters and the collected second plurality of device parameters associated with the second user device as input, to generate an updated baseline user profile associated with the first user of the first user device as output.

10. The method of claim 8, further comprising:
in response to denying the eSIM modification request from the second user device, transmitting an identity verification request to the second user device, wherein the identity verification request includes a request to provide a first biometric input from the second user device;
in response to transmitting the identity verification request, receiving the first biometric input from the second user device;
comparing the received first biometric input with the first biometric parameter to determine if the received first biometric input matches with the first biometric parameter;
in response to determining that received first biometric input matches with the first biometric parameter, allowing the eSIM modification request from the second user device; and
transmitting a successful eSIM modification request notification to the first user device.

11. The method of claim 8, further comprising:
in response to determining that the second biometric parameter does exceed the first baseline value, generating a third value;
in response to determining that the second device parameter does exceed the second baseline value, generating a fourth value; and
generating a second average value based on the third value and fourth value.

12. The method of claim 11, further comprising:
in response to determining that the second average value exceeds the threshold value, determining that the second user device is not a malicious user device and allow the eSIM modification request from the second user device; and
transmitting a successful eSIM modification request notification to the first user device.

13. The method of claim 8, wherein the plurality of eSIM configuration parameters comprises one or more of a phone number associated with the eSIM, a carrier URL (Uniform Resource Locator), SM-DP+ server address (Subscription Manager Data Preparation Address), a data roaming status indicator, and/or a network selection indicator.

14. The method of claim 13, wherein the eSIM modification request is a request to transfer the phone number associated with the eSIM onto the second user device.

15. A non-transitory computer-readable medium storing instructions that, when executed by a processor, cause the processor to:
receive an eSIM (embedded Subscriber Identity Module) monitoring request from a first user device, wherein the eSIM monitoring request comprises a user registration credential associated with a first user of the first user device;
verify the received user registration credential matches a first user credential stored in a user profile of the first user;
in response to verifying that the received user registration credential matches the stored first user credential, initiate monitoring of an eSIM of the first user device and, in response to initiating the monitoring of the eSIM of the first user device:
collect and store a plurality of eSIM configuration parameters associated with the eSIM of the first user device, wherein the plurality of eSIM configuration parameters includes a first eSIM configuration parameter;
collect a plurality of biometric parameters associated with the first user of the first user device, wherein the plurality of biometric parameters includes a first biometric parameter;
collect a plurality of device parameters associated with the first user device, wherein the plurality of device parameters includes a first device parameter; and
execute an AI algorithm using the collected plurality of biometric parameters and the plurality of device parameters as input, wherein the AI algorithm is configured to generate a baseline user profile associated with the first user device as output, wherein the AI algorithm is trained to generate the baseline user profile associated with the first user of the first user based on the plurality of biometric parameters and the plurality of device parameters and wherein the baseline user profile stores a first baseline value associated with the first biometric parameter, a second baseline value associated with the first device parameter;
receive an eSIM modification request from a second user device, wherein the eSIM modification request is a request to transfer the first eSIM configuration parameter associated with the eSIM onto the second user device; and
in response to receiving the eSIM modification request:
collect a second plurality of biometric parameters associated with the second user device, wherein the second plurality of biometric parameters includes a second biometric parameter;
collect a second plurality of device parameters associated with the second user device, wherein the second plurality of device parameters includes a second device parameter;
compare the second biometric parameter with the first baseline value associated with the first biometric parameter and determine if the second biometric parameter exceeds the first baseline value based on the comparison;
in response to determining that the second biometric parameter does not exceed the first baseline value, determine that the second biometric parameter is a first suspicious parameter, wherein the first suspicious parameter is assigned a first value;
compare the second device parameter with the second baseline value associated with the first device parameter and determine if the second device parameter exceeds the second baseline value based on the comparison;
in response to determining that the second device parameter does not exceed the second baseline value, determine that the second device parameter is a second suspicious parameter, wherein the second suspicious parameter is assigned a second value;
generate an average value based on the first value and the second value;
determine if the average value exceeds a threshold value;
in response to determining that the average value does not exceed a threshold value, determine that the second user device is a malicious user device and deny the eSIM modification request from the second user device; and
transmit a suspicious activity alert to the first user device and a cellular network carrier.

16. The non-transitory computer-readable medium of claim 15, wherein the instructions further cause the processor to:
in response to determining that the average value exceeds the threshold value, determine that the second user device is not a malicious user device and allow the eSIM modification request from the second user device; and
re-train, the trained AI algorithm, based on the collected second plurality of biometric parameters and the collected second plurality of device parameters associated with the second user device as input, to generate an updated baseline user profile associated with the first user of the first user device as output.

17. The non-transitory computer-readable medium of claim 15, wherein the instructions further cause the processor to:
in response to denying the eSIM modification request from the second user device, transmit an identity verification request to the second user device, wherein the identity verification request includes a request to provide a first biometric input from the second user device;
in response to transmitting the identity verification request, receive the first biometric input from the second user device;
compare the received first biometric input with the first biometric parameter to determine if the received first biometric input matches with the first biometric parameter;
in response to determining that received first biometric input matches with the first biometric parameter, allow the eSIM modification request from the second user device; and
transmit a successful eSIM modification request notification to the first user device.

18. The non-transitory computer-readable medium of claim 15, wherein the instructions further cause the processor to:
in response to determining that the second biometric parameter does exceed the first baseline value, generate a third value;
in response to determining that the second device parameter does exceed the second baseline value, generate a fourth value; and
generate a second average value based on the third value and fourth value.

19. The non-transitory computer-readable medium of claim 18, wherein the instructions further cause the processor to:
in response to determining that the second average value exceeds the threshold value, determine that the second user device is not a malicious user device and allow the eSIM modification request from the second user device; and
transmit a successful eSIM modification request notification to the first user device.

20. The non-transitory computer-readable medium of claim 15, wherein the eSIM modification request is a request to transfer a phone number associated with the eSIM onto the second user device.
